(19) United States
(12) Patent Application Publication
(10) Pub. No.: US 2002/0167142 A1
(43) Pub. Date: Nov. 14, 2002

(54) Foldable handle for a skateboard or a ski board

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/850,090

(22) Filed: May 8, 2001

(51) Int. Cl. B62M 1/00

(52) U.S. Cl. 280/87.041; 280/87.021

(57) ABSTRACT

A foldable handle for a skateboard a ski board comprises a pipe erecting upwardly from the front end of the board and a tightened tube having a quick-release wrench secured thereat. The tightened tube has a positioning part extending a block therefrom, which seats in a slot of the pipe. A connecting rod located at a lower end of the front strut. The connecting rod is inserted into the pipe and secured by the tightened tube, and is composed of an upper section and a lower section. Each of the upper and the lower sections has a slot corresponding to the block of the positioning part. Thus, when the lower section is inserted into the pipe, the upper section has a recess at its end and the lower section has a stud which is inserted into the recess in a normal situation. When pulling the front strut upwardly, the recess will depart from the stud, thus the front strut may be folded.

### BACKGROUND OF THE INVENTION

1. Field of the Invention

This invention relates to a foldable handle for a skateboard or a ski board, more particularly to a foldable strut which may be secured afterwards.

2. Description of the Related Prior Art

A conventional skateboard is generally composed of two wheel sets with one at front and at rear end, each wheel set has an axle connecting a pair of wheels at respective ends. There is elastic material between the wheel sets and wheels as shock absorption and it allows the board to incline so as to change direction during riding the board. In order to attract consumers, and also for the sake of safety, a new board with a handle is derived later on. This design is to secure a handle at the front end of the board and directs the front wheels to turn as well.

However, this design takes a lot of storage space and is inconvenient in carrying.

In view of this, the inventor has invented the present invention, which handle is foldable to save storage space and is easy for carrying.

### SUMMARY OF THE INVENTION

It is the primary of the present invention to provide a foldable handle for a skateboard or a ski board, which handle is foldable to have a compact size for storage and easy to carry.

It is another object of the present invention to provide a foldable handle for skateboard or a ski board, which is easy to operate.

It is a further object of the present invention to provide a foldable handle for a skateboard or ski board, which is safe in use.

### BRIEF DESCRIPTION OF THE DRAWINGS

FIG. 1 is a perspective view of the present invention;

FIG. 2 is an exploded view of the present invention;

FIG. 3 is a front view of the present invention, partially sectioned;

FIG. 4 is a view similar to FIG. 3, demonstrating the first step of folding the handle;

FIG. 5 is a partial side similar, demonstrating the second step of folding the handle;

FIG. 6 is a full side view showing the handle being folded and secured thereat; and

FIG. 7 depicts a ski board incorporated with the present invention.

### DETAILED DESCRIPTION OF THE PREFERRED EMBODIMENT

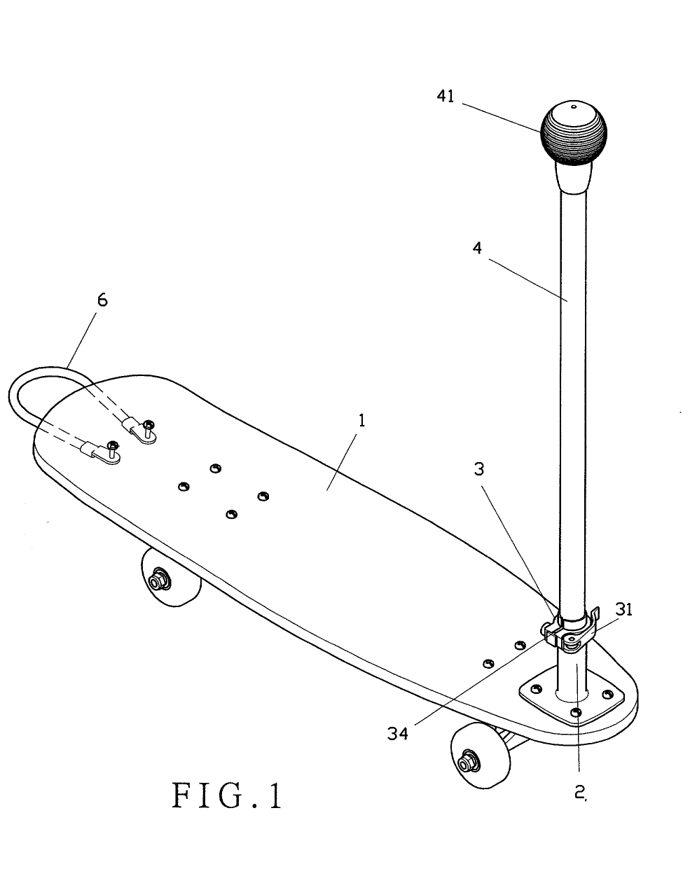

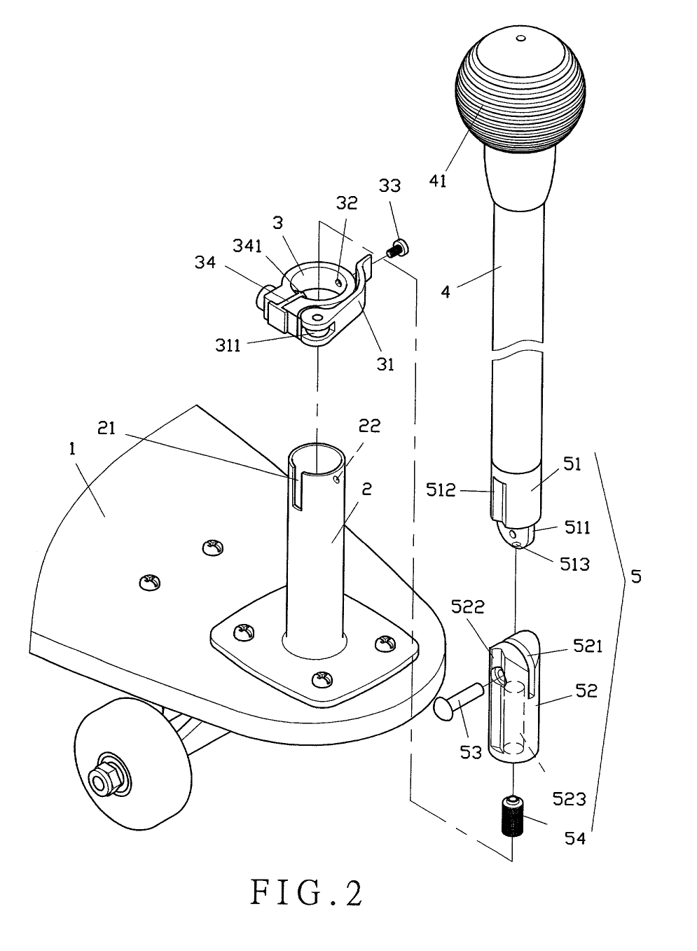

A foldable front strut 4 for skateboard 1 of the present invention, as shown in FIGS. 1 and 2, comprises a connecting pipe 2, and a tightened tube 3 with a quick-release wrench 31 sleeved thereon to the front strut 4 having a handle 41 thereat in a foldable manner.

The connecting pipe 2 has a slot 21 and a hole 22 on the upper side wall to sleeve the tightened tube 3 onto the pipe 2. A screw 33 inserting through a hole 32 of the connector 3 will be threaded into the hole 22 to secure the tightened tube 3 at place. The tightened tube 3 is secured by a pin 311, and has a positioning part 34 having a block 341 at one end to be slid into the slot 21 of the pipe 2 along with the tightened tube 3.

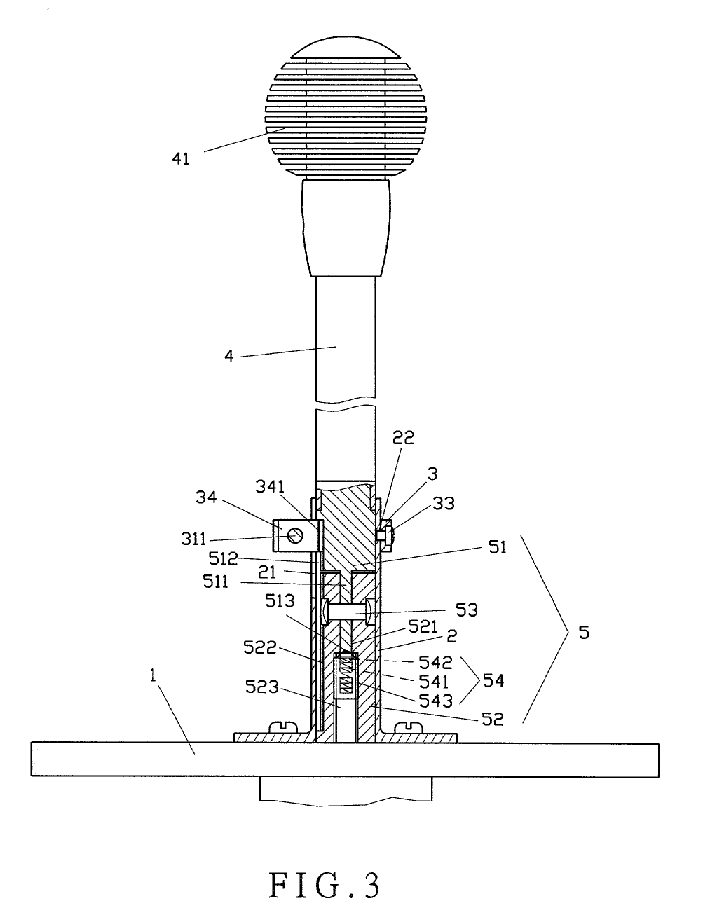

The front strut 4 has a connecting rod 5 at the lower end thereof inserted into the pipe 2. The connecting rod 5 comprises an upper section 51 having a tenon 511 to be inserted into a mortise 521 of a lower section 52, and is secured by a rivet 53 thereat. Both of the upper section 51 and the lower section 52 are formed with slots 512 and 522 at one side and corresponding to each other and to the slot 21 as well. These slots 512 and 522 of the upper section 51 and the lower section 52 are for the block 341 to slide there along and to stay therein. The lower section 52 stays in the pipe 2 and is secured in a constant manner. A stud 54 comprises a spring 541 and a bearing 542 containing in a cylinder 543, which urges the stud 54 to stay in a hole 523 at the bottom end f the lower section 52 and all the way up into a recess 513 of the upper section 51, as shown in FIG. 3

After assembly, as shown in FIG. 3, the tightened tube 3 sleeves on the pipe 2 and the connecting rod 5 at the lower end of the front strut 4 seats in the pipe 2. The block 341 is sleeved into the slot 21 and sliding onto the slots 512 and 522 of the upper section 511 and the lower section 521 to confine the front strut 4 from turning and also to facilitate extending and contracting along the slots. The upper section 51 and the lower section 52 will be secured by the bearing 542 of the stud 54 at place, and enwrapped by the tightened tube 3 in the pipe 2, thus the skateboard has a secured handle.

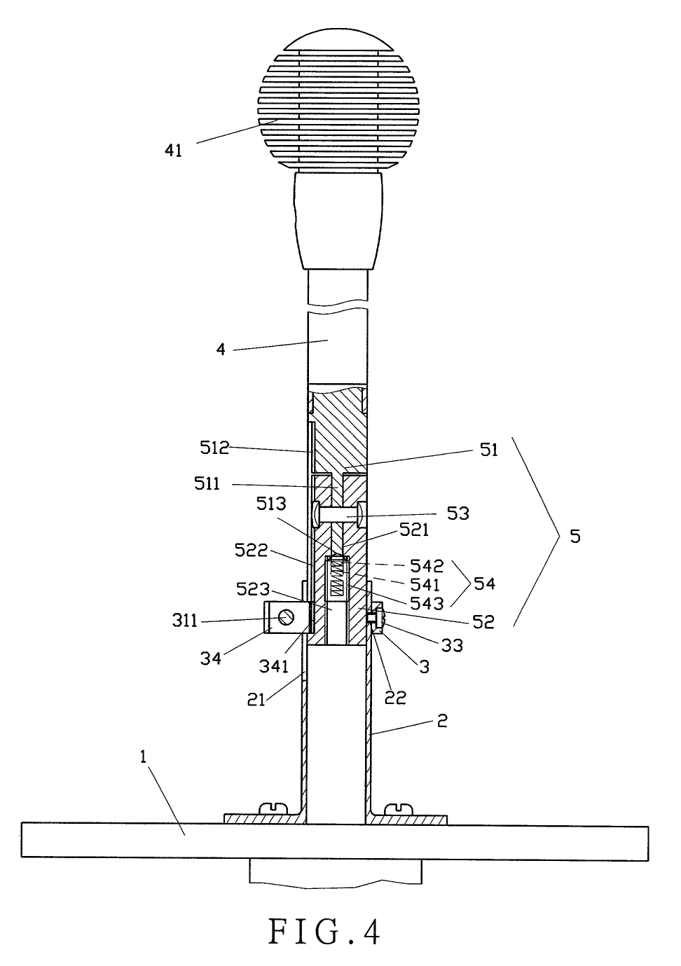

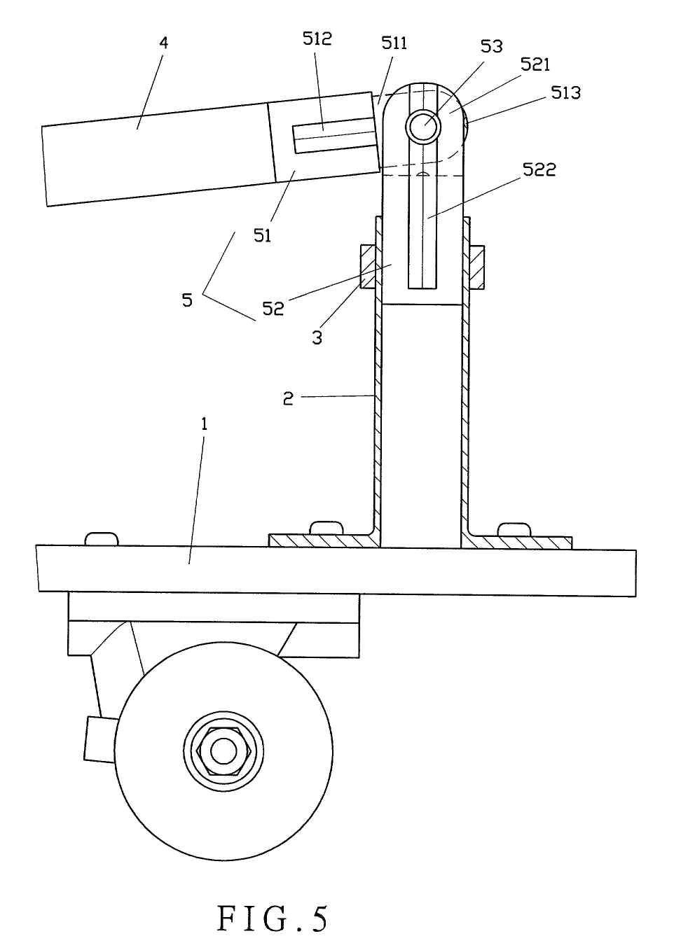

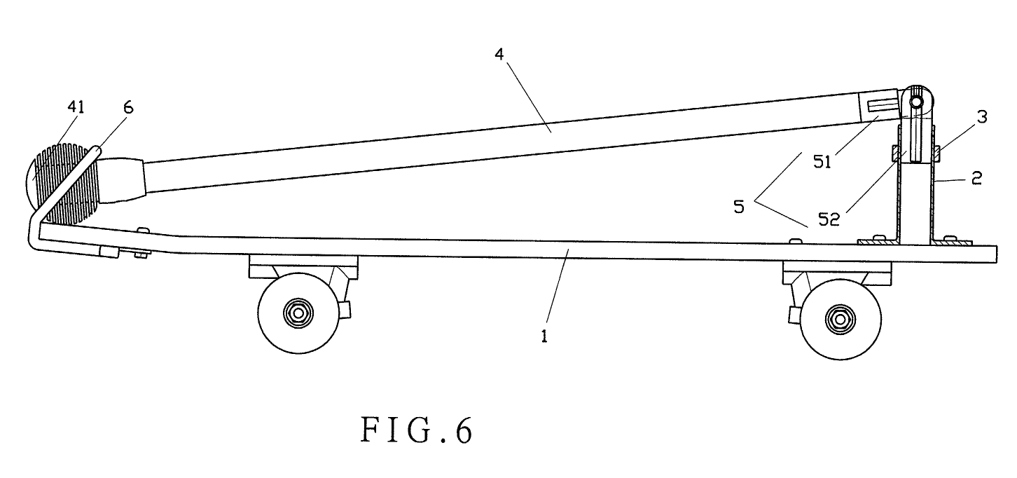

To collapse the front strut 4, the quick-release wrench 31 of the tightened tube 3 is first released, and then the front strut 4 is pulled upwardly, as shown In FIG. 4 to bring the upper section 51 until the upper section 51 is deposed from the pipe 2. Whereas the block 341 will engage with the bottom end of the slot 523 of the lower section 52, which confines further pulling movement. The upper section 51 is bendable with respect to the lower section 52, as shown in FIG. 5, and is secured by an elastic hook 6, as shown in FIG. 6.

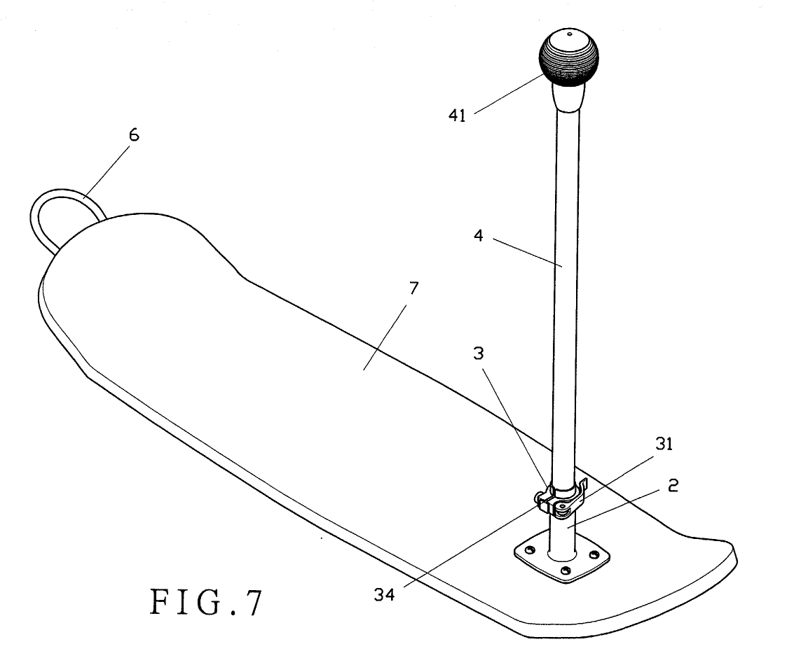

All of the above examples are for skateboard, however, other board, such as a ski board may also be applied to the present invention. That is to install the pipe 2 to the front end of the board 7, as shown in FIG. 7, and the tightened tube 3, the front strut 4, the connecting rod 5 are all identical to the design for skateboard.

I claim:

1. A foldable handle for a skateboard or a ski board comprising a pipe secured to the front end of said skateboard to receive a lower portion of a strut therein, securely, and the improvements comprising:
said pipe having a slot at one side wall, and being sleeved with a tightened tube having a quick-release wrench, said tightened tube being secured by a pin, having a block at one end to be inserted into said slot of said pipe, and a hole for a screw to insert therethrough and into a hole on the side wall of said pipe to position said tightened tube at place,
the lower end of said front strut being formed with a connecting rod to being inserted into said pipe, said connecting rod comprising an upper section and a lower section, wherein each said upper section and said lower section being formed with a slot at one side and corresponding to each other and to said slot of said pipe for a block to slide therein and therealong, and whereas said lower section remaining in said pipe constantly, said lower section having a mortise and said upper section having a tenon corresponding to said mortise of said upper section;
by releasing said quick-release wrench of said tightened tube and pulling said front strut, said upper section of said connecting rod will be departed from said lower section and being able to bend.

2. The foldable handle for a skateboard or a ski board, as recited in claim 1, wherein the connecting rod 5 comprises an upper section having a tenon 511 to be inserted into a mortise of a lower section, and is secured by a rivet thereat, a hole being formed at the bottom end of the lower section for a stud to insert therethroughm, said stud comprising a spring and a bearing containing in a cylinder, a recess being formed at the bottom of the upper section for engaging said bearing.

3. The foldable handle for a skateboard or a ski board, as recited in claim 1, wherein said skateboard comprises an elastic hook at a rear end of said skateboard to secure said front strut.
